(19) United States
(12) Patent Application Publication
(10) Pub. No.: US 2009/0205582 A1
(43) Pub. Date: Aug. 20, 2009

(54) MOBILE DEVICE DOG WHISTLE

(75) Inventor: Stephen Anthony Kitchens, Durham, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIOS AB, Lund (SE)

(21) Appl. No.: 12/031,795

(22) Filed: Feb. 15, 2008

(51) Int. Cl. A01K 15/04; A01K 15/02

(52) U.S. Cl. 119/719; 340/384.2

(57) ABSTRACT

A mobile device, upon user selection and actuation, transmits an ultrasonic frequency signal into the area surrounding the mobile device, at a signal intensity capable of being heard by animals present in such area, whereby the transmitted ultrasonic signal is suitable for use as a defense measure and, alternately, as a training measure for animals present in the transmission area.

### BACKGROUND OF THE INVENTION

This invention relates to mobile devices, and more particularly to mobile devices which provide user controlled ultrasonic frequency signals.

Mobile devices, such as wireless personal data assistant (PDA), personal communication service (PCS), palm top computer, satellite telephone, and radio frequency cellular telephone devices, offer users an ever increasing array of functional features in addition to their mobile communications capability. This has led to their wide acceptance and worldwide distribution to the extent that they are now ubiquitous in all developed countries. In accomplishing this they have moved from a discretionary use item to a necessary, or even must have status for business and personal use. As a result they are now carried by an ever increasing segment of the population.

The popularity and functional necessity of these mobile devices ensure that they are as likely to be carried on the person of their owners as are other essentials, such as house keys, wallets, handbags, and attaché cases. This ready availability offers a possibility of having the mobile devices also perform functions which are outside of the communications, data retrieval, or entertainment realms, but which relate to personal safety. On such personal safety function could be the use of a mobile device as a defense against aggressive animals. In particular aggressive dogs.

Many people have a conscious fear of dogs to the extent that if they encounter a dog while walking they will detour to avoid approaching too closely. Also, increasing media reports of dogs attacking humans in pubic have raised an awareness of the danger among the public at large. Especially in respect to certain breeds of dogs which have a reputation for aggressive behavior. Coupled with this awareness is the reality that it is not unusual to see stray or unleashed dogs roaming freely in dense population areas. While in most instances there is no interaction between dog and person, there remains the possibility of interaction and, for many, the fear of attack.

There are avoidance measures that persons can take to minimize their exposure, with detour being the easiest. However, there are many settings where detour is impractical or ineffective in that the person remains in sight of the dog and can be charged and attacked. Detour may also be impossible when the dog is at the intended destination or proximate to members of the person's family. In those instances it may be necessary to resort to known measures to force the dog to back away from you and those with you. One known measure is the use of ultrasonic sound waves which are audible to dogs and other animals (deer, pests, etc.) but not to humans.

The term ultrasonic refers to frequencies above human audible sound, which is generally identified as from 20 Hz to 20,000 Hz. Ultrasonic then is anything over 20,000 Hz. There are prior art devices, both mechanical and electronic, which are known for use in generating ultrasonic waves to startle or otherwise gain the attention of animals, without disturbing humans. The mechanical devices are whistles which are used by animal trainers, primarily dog trainers, to command specific actions and/or behavior of the dog. The trainer simply blows the whistle for different duration intervals or different intensity which is associated with different specific commands.

The electronic versions are electronic sound generators powered by an electrical service or battery, and are most commonly used to remove animal pests (deer, dog, coyote) from property. They are positioned on the property and actuated by proximity sensors which detect the animal's presence. Their sound startles the animal which usually always then causes them to retreat or turn away. Aside from its startle effect, the signal level may also be made intense enough to be unpleasant to the animal, but not injure them.

Either of the mechanical or electronic ultrasonic whistles are available in model sizes which are small enough to be easily carried by individuals on their person, and the same ultrasonic sound generation can then be used as necessary to ward off dogs that the individual encounters. The shortcoming of these devices, however, is their availability when needed. It would require consistent or high probability encounters with stray or unleashed dogs to readily discipline someone to remember to carry the device, as well as ensuring that the batteries of such electronic versions are charged. It would instead be highly useful, and substantially more practical, to have such an ultrasonic generation capability in the person's mobile device itself.

### BRIEF SUMMARY OF THE INVENTION

According to one embodiment of the present invention, a method enables a mobile device, upon activation by the mobile device user, to transmit an ultrasonic signal at a frequency greater than 20,000 Hertz into a surrounding broadcast area to have the mobile device function as a defense measure and, alternately, as a training measure for animals. According to this embodiment transmission of the ultrasonic signal is presented to the user as a menu option accessible through the mobile device user interface, this option offering the user the choice of a push and hold and, alternately, a toggle on transmission of the ultrasonic signal, and providing display of an ultrasonic signal icon on the mobile device user interface in the presence of such transmission.

In further accord with this embodiment the method provides the user with the option, when the ultrasonic signal is generated in response to user selection as a defense measure, of placing an automated call for assistance to a rescue service. In still further accord with this embodiment, the method provides an audible message request for assistance to the rescue service as well as an audible message notifying the rescue service of the current global positioning system (GPS) coordinates of the mobile device. In yet still further accord with this embodiment, the method provides the user with the ability to generate a pulsed ultrasonic frequency signal as a training measure for use with animals.

According to another embodiment of the invention, a mobile device, upon actuation by a mobile device user, transmits an ultrasonic frequency signal into its surrounding area, at a signal intensity sufficient to be heard by animals in the area, whereby the transmitted ultrasonic signal may be used as a defense measure and, alternately, as a training measure for animals. In further accord with this embodiment of the invention the ultrasonic signal frequency is greater than 20,000 Hz. In still further accord with this to embodiment, the mobile device presents the ultrasonic signal transmission to the device user as a menu option which is accessible through the device user interface, and it is offered as a choice of a push and hold and, alternately, a toggle-on transmission control format, the mobile device displaying an ultrasonic signal icon on the user interface display in the presence of the ultrasonic transmission. IN yet still further accord with this embodiment the mobile device will, upon command of the device user during transmission of the ultrasonic signal, automatically notify a rescue agency of the existence of a human emergency at the global positioning service (GPS) location of the mobile device.

In further accord with this embodiment the mobile device provides the user with the option, when the ultrasonic signal transmission is in response to user selection as a defense measure, of placing an automated call for assistance to a rescue service, the mobile device providing such call with an audible message requesting assistance and a notice of the current global positioning system (GPS) coordinates of the mobile device. In yet still further accord with this embodiment, the method provides the user with the ability to generate a pulsed ultrasonic frequency signal as a training measure for use with animals.

According to still another embodiment of the invention an ultrasonic signal computer program product provides a computer usable medium having computer usable program code embodied therewith which provides, in its execution, in response to operator command, the generation and transmission of an ultrasonic frequency signal, into a broadcast area immediate surrounding the device, the ultrasonic frequency signal having a signal intensity sufficient to be heard by any animal within the broadcast area. In further accord with this to embodiment of the invention the ultrasonic signal frequency is greater than 20,000 Hertz. In still further accord with this embodiment the mobile device will, upon operator command during the broadcast of the ultrasonic signal, automatically notify a rescue agency of the existence of a human emergency at the global positioning satellite location of the mobile device.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWING

FIG. 1, is a plan view of a first major surface of a radio frequency cellular telephone mobile device in which the present invention may be used;

FIG. 2, is a plan view of a second major surface of the mobile device of FIG. 1;

FIG. 3, is a simplified schematic block diagram of the mobile device of FIGS. 1 and 2; and

FIG. 4, is a flow chart diagram of the steps performed in an exemplary embodiment of the invention in operation in the mobile device of FIGS. 1 through 3.

### DETAILED DESCRIPTION OF THE INVENTION

As will be appreciated by those skilled in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Exemplary embodiments of the invention are here described with respect to a radio frequency cellular telephone mobile device, however, it should be understood that the invention may also be used with any of the various alternative types of mobile devices that are known to those skilled in the art, including wireless personal data assistant (PDA), personal communication service (PCS), palm top computer, lap top computer, and satellite telephone mobile devices.

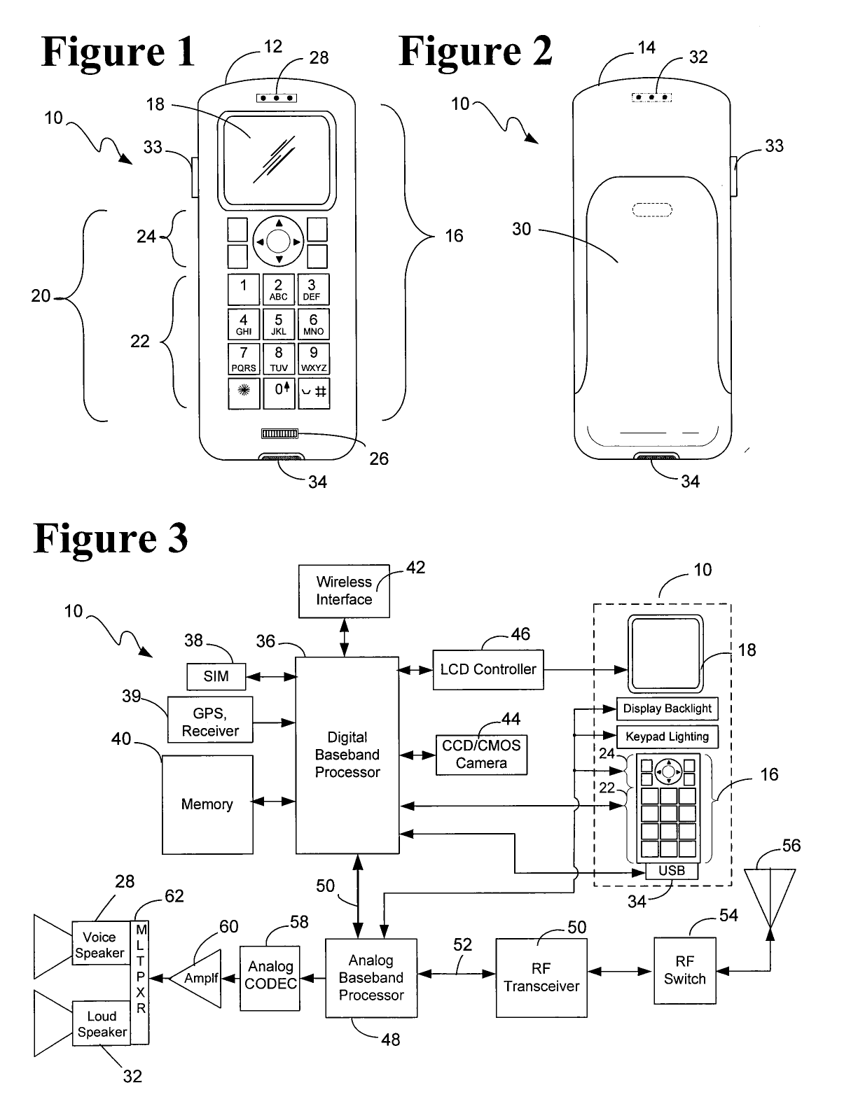

Referring simultaneously now to FIGS. 1 and 2, a radio frequency cellular mobile device 10 has a first, or front side 12 and a second or back side 14. The front side 12 provides a user interface 16 having a display 18 and a keypad 20. The keypad has alphanumeric keys 22 and navigation control keys 24 from which the user may enter data and select user functions from among choices that are shown on the display 18. The front surface 12 of the mobile device 10 also includes a microphone 26 and voice speaker 26 which allow the user to perform telephonic communication. The second, or back side 14 of the mobile device 10 includes an access cover 30 to the cellular telephone battery (not shown) and a loud speaker 32. A user operated button 33 switches the output audio between the voice speaker 26 and the loud speaker 32. The mobile device phone 10 also includes a universal serial bus (USB) 34 which may be used to exchange data and communicate with external devices and to receive electrical power to charge the mobile device battery.

Referring to FIG. 3, in a schematic block diagram of the cellular telephone mobile device 10 of FIGS. 1 and 2, a digital baseband processor 36 is connected for response to the USB 34, a subscriber identity module (SIM) 38, a Global Positioning System (GPS) receiver 39, memory 40, and wireless interface 42. As known, the GPS receiver 39 provides the processor 36 with the real time GPS coordinates (latitude and longitude) of the mobile device. The memory 40 includes both volatile random access memory (RAM) for storing temporary data and/or instructions, and non-volatile read-only memory (ROM) for storing computer program signals, including operating instructions and data required for operation of the mobile device 10. The memory 40 may be implemented in one or all of a combination of EPROM, EEPROM and flash memory devices. The wireless interface 42 allows the device 10 to access the world wide web (www) and download digital data, multimedia content, and executable computer programs. The digital baseband processor receives video data from a CCD/CMOS camera 44 and exchanges commands with the LCD Controller 46 to control presentation of the data content, including application menus on the display 18.

The mobile device 10 also includes an analog baseband processor 48 which exchanges communications with the digital baseband processor through bus 50 and digital to analog (DAC) converter (not shown) but within the illustrated functional block of the analog baseband processor 48. The analog processor 48 exchanges received and transmitted analog voice signals with a radio frequency (RF) transceiver 50 over a dual channel link 52, which are received and communicated through RF switch 54 to the antenna 56 of the mobile device.

The analog processor 48 also receives the user entered data and commands from the keypad 20 (FIG. 1). This includes alphanumeric data entered by the user as well as user navigation commands entered though controls 24 (FIG. 1). Audio signal output from the analog processor 48 is presented through an audio CODEC 58 and audio amplifier 60 to a multiplexer 62. The multiplexer 62 switches the output audio between the voice speaker (28, FIG. 1) for reception at the ear of the user and the loud speaker (32, FIG. 2) in response to the command of the functional application requesting use of the loud speaker for this specific application. This application request overrides the ability of the user to change speakers using the loudspeaker button 33 (FIGS. 1, 2).

The present invention provides the mobile device 10 with the added functional capability of generating an ultrasonic frequency signal. This is a signal frequency which is above the 20,000 Hz upper frequency limit of human audible sound. In a preferred embodiment of the invention the ultrasonic signal would be at a selected set point frequency of 20,000 Hz+/−2,000 Hz depending on what the system can achieve with available speaker selection and the mechanical enclosure design. Any frequency in this range is acceptable for the defensive measure in preventing an attack by a dog or other animal. The amplitude of the ultrasonic signal will be pre-set to a maximum limit by having the analog codec 58 (FIG. 3) set to maximum output power for the defense measure application.

In this exemplary embodiment the ultrasonic signal, or “animal whistle” is generated by the digital baseband processor 36 and forwarded to the analog baseband processor 48 over bus 50. There it is converted by the analog processor's analog to digital converted (not shown) to an analog ultrasonic audio signal. It is sent to the analog CODEC 58, which amplifies and filters it for audio playback. The multiplexer 62 then presents the ultrasonic frequency signal to the loud speaker 32 for broadcast into the mobile device surrounding area.

In this exemplary embodiment the invention is embodied in a software program module, such as a JAVA applet which may be loaded into the mobile device memory 40 through the USB 34 or by download through the wireless interface 42. As a resident application the module will be run as a continuous background operating function that may be actuated by the user through the interface 16 (FIG. 1) such as by using the navigation keys 24 to access a menu option that allows the user to select the ultrasonic signal frequency, which is hereinafter alternately referred to a “whistle” in recognition of dog whistles which have known behavioral response characteristics among dogs.

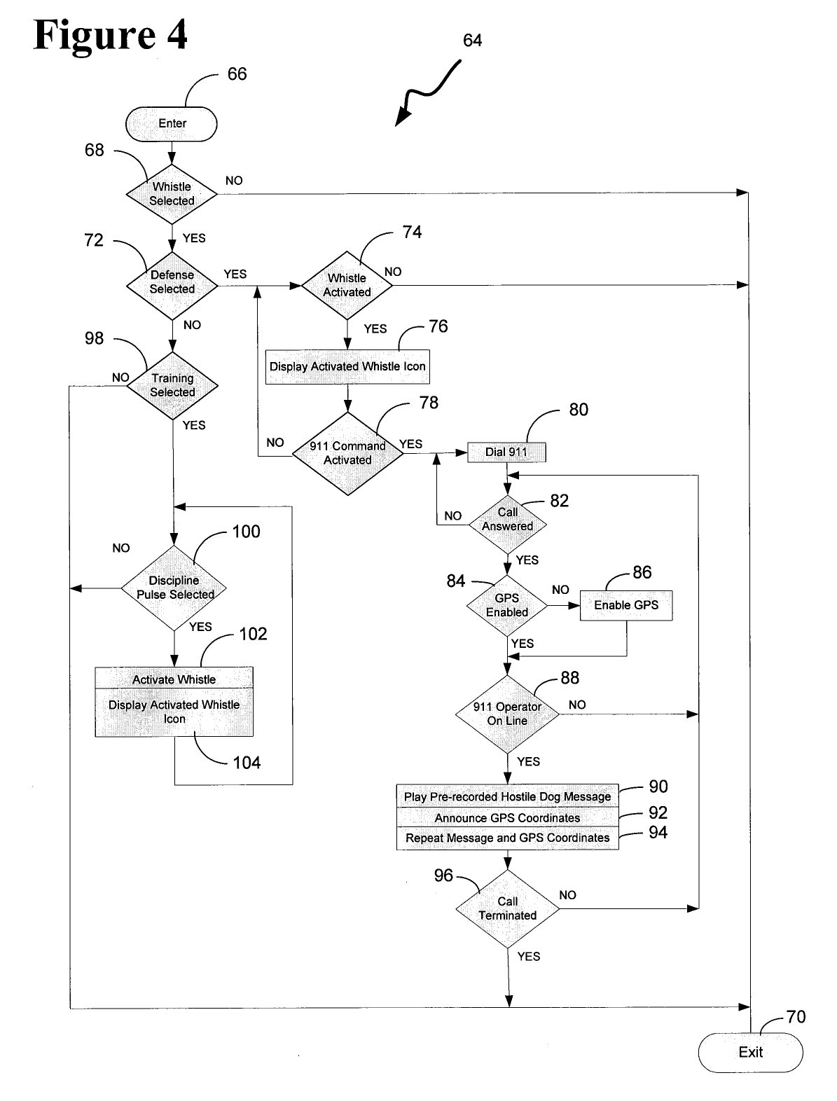

Referring now to FIG. 4, in a flow chart diagram 64 of the algorithm performed by the invention in this exemplary embodiment, the mobile device digital processor 36 enters the flowchart at 66 and decision 68 requires a determination of whether the whistle function has been selected by the user. If the answer is NO the processor exits at 70. If the answer is YES, decision 72 determines if the defense means, or mode, has been selected. If the answer is YES, decision 74 determines if the whistle has been activated. There is a provision in the algorithm which allows the user to select the defense function but pause before activating the whistle to generate the ultrasonic signal frequency. This permits flexibility in the user's reaction to the given circumstances.

If the whistle is not activated a NO answer has the processor again exits the routine at 70. If the whistle is activate a YES answer has instructions 76 display an activated whistle icon on the mobile device display 18 (FIG. 1) to confirm activation to the user. Decision 78 next determines if the user has activated a 911 command, which is a command to call for assistance. This may be any rescue agency that has been a prior election by the user and programmed into the routine. If the rescue command has not been activated the routine branches back to the decision 74. If at any time the user elects not to activate the rescue call and then deactivates the whistle the processor exits the routine at 70.

If the 911 command is activated instructions 80 automatically dial the rescue agency telephone number which is 911 as a default. Decision 82 determines if there is a ring tone and if NO then branches back to instructions 80 and redials the rescue agency number. If there is a dial tone decision 84 determines if the mobile device global positioning service (GPS) is activated and if NO instructions 86 enable the GPS. Decision 88 next determines if a 911 operator is on the line. If NO the program branches back to decision 82 to determine ring tone and if necessary (no ring tone) then branches back to instructions 80 and redials the 911 number.

With a 911 operator on the line and GPS activated, instructions 90 play a pre-recorded hostile dog message for transmittal to the 911 operator and instructions 92 supplement that with an audible annunciation of the present GPS location of the mobile device. Instructions 94 then repeat the voice message and GPS coordinates a second time. decision 96 next determines if the call has been terminated by the user. If NO, the routine branches back to detect a ring tone (in the event of a dropped call) and again executes the above described steps. If the call has been terminated by the user the processor exits at 70.

Referring back to the decision 72, if the defense function has not been activated a NO answer results in decision 98 determining if the training function has been selected. If not, a NO answer causes the processor to exit at 70. If YES, decision 100 determines if a discipline pulse has been selected by the user. As in the defense mode the user may elect the training mode but pause in their activation of the function. In that case, if no discipline pulse has been activated, the processor exits at 70. If the discipline pulse has been activated instructions 102 activate the whistle and instructions 104 display the activated whistle icon on display 18 (FIG. 1). The routine then branches back to decision 100 and again executes the steps, and exits when the discipline pulse is no longer selected.

In the exemplary embodiment the ultrasonic signal is a fixed high frequency ultrasonic sound of 20,000 Hz+/−2,000 Hz that will force a dog to keep its distance. The intensity level is selected to provide a most effective deterrent within a target zone that is centered on the mobile device and extends therefrom at a radius of up to fifteen feet. At the greater distances associated with commanding dog behavior, such as 75 feet to 100 feet the signal intensity is strong enough to be heard by the animal but not at a disagreeable level that would harm or distract the dog from the commanded act.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

We claim:

1. A mobile device, comprising:
a user interface, having a keypad and an information display, the keypad being responsive to entries by a user that command operation of the functional applications that the mobile device is programmed to perform;
computer signal processing means, for executing computer program instructions to provide machine commanded instructions that perform the user commanded functional applications, including a wireless communications function, the computer signal processing means having memory means for storing signals, including the computer program instruction signals that are executed by the computer signal processing means to provide the machine commanded instructions;
a voice speaker and a load speaker, each capable of providing human audible sounds in response to sonic frequency electrical signals presented thereto, the load speaker providing such human audible sounds at an intensity level to be heard by humans in the mobile device surrounding area; and
signal amplification means responsive to the machine commanded instructions from the computer signal processing means to present the sonic frequency electrical signals to the voice speaker;
as characterized by:
the functional applications performed by the mobile device including transmission of an ultrasonic frequency sound that is controllably actuated by the user to function as a defense measure and, alternately, as a training measure in respect of animals present in the mobile device area, the computer signal processing means providing in response to user actuation of the ultrasonic function, machine commanded instructions to the signal amplification means to generate an ultrasonic frequency electrical signal and, in response thereto, transmit an ultrasonic frequency sound; and wherein
the loud speaker is capable of further providing, addition to human audible sounds, the transmission of ultrasonic frequency sounds in response to ultrasonic frequency electrical signals presented thereto by the signal amplification means, the loud speaker transmitting such ultrasonic frequency sounds at an intensity level to be heard by animals in the mobile device surrounding area.

2. The mobile device of claim 1, wherein the computer signal processing means, upon user selection of the ultrasonic frequency sound function, activates one or more control keys on the user interface to provide the user with the ability to select the defense measure and, alternately, the training measure, and to control the duration of the ultrasonic frequency sound transmission.

3. The mobile device of claim 2, wherein the computer signal processing means requires user selection of the ultrasonic frequency sound function and either the defense measure or the training measure before commanding the transmission of the ultrasonic frequency sound.

4. The mobile device of claim 3, wherein the computer signal processing means provides the user, upon user selection of the defense measure, with the ability to command transmission of the ultrasonic frequency sound using control keys on the user interface in a toggle-on and toggle-off mode, wherein the ultrasonic frequency sound will, when toggled on, continuously transmit until toggled off.

5. The mobile device of claim 3, wherein the computer signal processing means provides the user, upon user selection of the training measure, with the ability to command transmission of the ultrasonic frequency sound using control keys on the user interface in a push and hold mode, wherein the ultrasonic frequency sound will transmit only for so long as the user pushes and holds the control key.

6. The mobile device of claim 4, further comprising:
a global position system (GPS) receiver which presents the computer signal processing means with the real time GPS coordinates of the mobile device; and wherein
the computer signal processing means has stored in memory means the telephone number of a rescue agency and, upon user commanded transmission of the ultrasonic frequency sound, presents the user with the election to have the mobile device place an automated telephone call to a rescue agency.

7. The mobile device of claim 6, wherein the computer signal processing means, in response to the user election to call a rescue agency, places an automated call to the rescue agency and upon establishing a connection provides the rescue agency with a voice message request for assistance together with a voice message reporting the current GPS coordinates of the mobile device.

8. The mobile device of claim 5, wherein the computer signal processing means, upon user press and hold of the control key in the training measure, transmits the ultrasonic frequency sound in a pulsed format.

9. The mobile device of claim 5, wherein the computer signal processing means provides the user the ability, with user selection of the training measure, to alter the frequency and, alternately, the pitch of the ultrasonic frequency sound transmission to thereby affect a greater measure of response from a broader specie of animals.

10. The mobile device of claim 9, wherein the computer signal processing means, in response to user selection of the training measure, transmits the ultrasonic frequency sound at an intensity and pitch to affect a greater measure of response from a dog that is in the mobile device surrounding area.

11. A computer program product for enabling a mobile device to generate an ultrasonic frequency sound that suitable for use by a mobile device user to perform defense measures and, alternately, training measures for animals within the mobile device surrounding area, the mobile device of a type having: signal processing means that executes computer program instructions to provide the machine commanded instructions that perform the various mobile device functional applications, including a wireless communications function, the mobile device further including memory means for storing signals, including computer program instruction signals that are executed by the computer signal processing means to provide the machine commanded instructions, a global positioning system (GPS) receiver, a user interface with a keypad and a display, signal amplification means responsive to the machine commanded instructions from the signal processing means, and a loud speaker capable of transmitting ultrasonic frequency sounds to the mobile device surrounding area in response to ultrasonic frequency electrical signals that it receives, the computer program product comprising:
a computer usable medium having computer usable program code embodied therewith, the computer usable medium comprising:
computer usable program code configured to have the mobile device signal processing means present menu options, viewable on the user display and accessible by user manipulation of the keypad, which allow user actuation of the ultrasonic frequency sound application; and
computer usable program code configured to cause the mobile device signal processing means to provide, in response to user actuation of the ultrasonic function, machine commanded instructions to the signal amplification means to present an ultrasonic frequency electrical signal to the loud speaker which, in response, transmits an ultrasonic frequency sound to the mobile device surrounding area.

12. The computer program product of claim 11, wherein the computer usable medium further comprises:
computer usable program code configured to have the mobile device signal processing means, upon user selection of the ultrasonic frequency sound function, activates one or more control keys on the user interface to provide the user with the ability to select the defense measure and, alternately, the training measure, and to control the duration of the ultrasonic frequency sound transmission.

13. The computer program product of claim 12, wherein the computer usable medium further comprises:
computer usable program code configured to have the mobile device signal processing means require user selection of the defense measure or the training measure in addition to the user selection of the ultrasonic frequency sound function before commanding the transmission of the ultrasonic frequency sound.

14. The computer program product of claim 13, wherein the computer usable medium further comprises:
computer usable program code configured to have the mobile device signal processing means provide the user, upon user selection of the defense measure, with the ability to command transmission of the ultrasonic frequency sound using control keys on the user interface in a toggle-on and toggle-off mode, wherein the ultrasonic frequency sound will, when toggled on, continuously transmit until toggled off.

15. The computer program product of claim 13, wherein the computer usable medium further comprises:
computer usable program code configured to have the mobile device signal processing means to provide the user, upon user selection of the training measure, with the ability to command transmission of the ultrasonic frequency sound using control keys on the user interface in a push and hold mode, wherein the ultrasonic frequency sound will transmit only for so long as the user pushes and holds the control key.

16. The computer program product of claim 13, wherein the computer usable medium further comprises:
computer usable program code configured to have the mobile device signal processing means store in the memory means the telephone number of a rescue agency and, upon user commanded transmission of the ultrasonic frequency sound, presents the user with the election to have the mobile device place an automated telephone call to a rescue agency.

17. The computer program product of claim 16, wherein the computer usable medium further comprises:
computer usable program code configured to have the mobile device signal processing means, in response to the user election to call a rescue agency, places an automated call to the rescue agency and upon establishing a connection provides the rescue agency with a voice message request for assistance together with a voice message reporting the current GPS coordinates of the mobile device.

18. The computer program product of claim 15, wherein the computer usable medium further comprises:
computer usable program code configured to have the mobile device signal processing means, upon user press and hold of the control key in the training measure, transmits the ultrasonic frequency sound in a pulsed format.

19. The computer program product of claim 15, wherein the computer usable medium further comprises:
computer usable program code configured to have the mobile device signal processing means provide the user the ability, with user selection of the training measure, to alter the frequency and, alternately, the pitch of the ultrasonic frequency sound transmission to thereby affect a greater measure of response from a broader specie of animals

20. The computer program product of claim 19, wherein the computer usable medium further comprises:
computer usable program code configured to have the mobile device signal processing means, in response to user selection of the training measure, transmits the ultrasonic frequency sound at an intensity and pitch to affect a greater measure of response from a dog that is in the mobile device surrounding area.
